(19) United States
(12) Patent Application Publication
(10) Pub. No.: US 2010/0227183 A1
(43) Pub. Date: Sep. 9, 2010

(54) THERMOPLASTIC MOLDED ARTICLE HAVING A METAL LAYER

(75) Inventors: Brett Collin Dobrick, Wilmington, DE (US); James McCutcheon, Bloomfield, MI (US); Benjamin Weaver Messmore, Wilmington, DE (US); Robert E. Penn, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/715,674

(22) Filed: Mar. 2, 2010

Related U.S. Application Data
(60) Provisional application No. 61/156,945, filed on Mar. 3, 2009.

(51) Int. Cl. B32B 27/36; B32B 27/06

(52) U.S. Cl. 428/458

(57) ABSTRACT

Disclosed is a thermoplastic molded article having at least one surface having a metal layer, wherein the article includes a poly(trimethylene terephthalate) molding resin having a cyclic dimer content of less than or equal to 1.1 wt %, as determined with nuclear magnetic resonance analysis, based on the weight of said poly(trimethylene terephthalate) repeat units and said cyclic dimer; and an intrinsic viscosity of 0.9 to about 2.0 dL/g. Preferably the metal layer is aluminum. Molded parts include vehicle light bezels including headlight, taillight, direction light bezels, and vehicle interior light bezels.

### CROSS REFERENCE TO RELATED APPLICATIONS

This application claims the benefit of U.S. Provisional Application No. 61/156,945, filed Mar. 3, 2009, which is incorporated herein by reference in its entirety.

### FIELD OF INVENTION

This invention is directed thermoplastic molded articles including a poly(timethylene terephthalate) molding resin, the article having at least one surface having a metal layer.

### BACKGROUND OF INVENTION

Molded articles comprising thermoplastic polymers are useful in the manufacture of optical reflectors, for example in automotive headlight extensions, bezels and reflectors, for indoor illumination, for vehicle interior illumination and the like. For instance, published patent application WO 2008/066988 discloses a composition comprising thermoplastic poly(butylene terephthalate) (PBT) and poly(ethylene terephthalate) (PET) useful in the manufacture of lighting articles, which can be directly metalized without inclusion of a base coat.

Poly(trimethylene terephthalate) (PTT) polyester, is another an attractive material for use in engineering resin applications as it provides physical properties and processing characteristics similar to other polyester resins, namely PBT. In addition, PTT can be a sustainable product being partially derived from renewably-sourced materials. One such PTT renewably—sourced material is Sorona® polymer, available from E. I. du Pont de Nemours & Co., Inc. Wilmington, Del., USA.

PTT has a higher equilibrium cyclic oligomer concentration, typically about 2.5% by weight based on the resin weight, when compared to similar polyesters such as PET or PBT, that typically have 1.4-1.8% by weight of cyclic oligomer. The most abundant cyclic oligomer of PTT is the cyclic dimer. When PTT resin molded parts are subjected to higher than normal temperature conditions (80° C. to 160° C.) the cyclic dimer of PTT is observed to bloom to the surface of the molded part, resulting in an undesirable cosmetic defect. The surface of a black part (containing carbon black) whitens with a crystalline powder of cyclic dimer. A related problem for polymer compositions, in particular polyester compositions and polymer compositions having a polyester component, is the release of low molecular weight components when heated, referred to as “outgassing”. This can be a particular problem in polymer parts that are often or even constantly subjected to high temperatures, such as a bezel, a housing for a lamp or a reflector for a lamp, all of which are heated by the lamp.

Outgassing can be classified as “volatile” or “condensable”. Volatile outgassing consists of lower molecular weight gaseous components, such as flavorants or odorants. Condensable outgassing refers to components that are driven off under heat or ambient conditions, and which condense on relatively cooler surfaces, forming an oily, waxy or solid deposit, which may be perceived as a haze or film. This effect is also known as ‘fogging’.

Condensable outgassing is a particular problem in components which must have a high degree of surface perfection, and in optical components where a film or deposit may be easily perceived and good transmission of light is important. For example, conventional bezels for headlamps are often made of thermoplastics, such as polyester, for instance PBT. The automotive headlamp assembly is an enclosed system containing metalized reflectors, light components and electrical connectors, headlamp adjusters etc., enclosed within a housing and a transparent lens cover which is usually produced from polycarbonate. Within this assembly, the bezel is a cover which is fitted around the light bulbs and reflectors to hide the internal workings. The bezel is an aesthetic/visible part, and is designed to look good. A high degree of surface perfection is required. There are several design types of thermoplastic bezels:
Metalized bezels: after injection molding, the polymer surface of the bezel is plated with a metal coating, usually aluminum. The polymer surface is often required to have a very high gloss surface with no surface defects visible. A direct metalization process using vacuum coating methods such as sputtering or evaporation methods, without use of surface primer is preferred.
Non-metalized bezels: such bezels may have a matt or textured appearance.
Combination bezels: a combination of metalized and non-metalized parts.

The bezel surrounds the reflector and light bulbs and is enclosed behind the transparent lens/headlamp cover. On prolonged heat exposure, due to the heat of the light bulb, or ambient conditions, such as strong sunlight, condensable outgassing from a conventional polyester bezel can condense on the transparent headlamp cover, leading to a visible film or deposit on the lens that is not only unattractive but which causes a decrease in light transmission.

In addition, condensable outgassing can cause problems in molding of a polymer part. During the production of polymer parts by injection molding, gradual release of condensable outgassing species onto, for example, the mold/tool surface, can result in the appearance of cloudy surface defects on the molded part. Such defects are particularly undesirable in parts such as bezels, in which a smooth, defect-free finish is desired. Such defects can sometimes be visible on parts molded in dark colors, and may become more visible after a direct metalization step. To avoid build up of this defect during a continuous molding operation, manufacturers must periodically shut down their molding machine for tool cleaning. This results in loss of time, increasing the cost of the molded part. The build up of such low a molecular weight film on the mold/tool is called mold deposit.

Furthermore, condensable outgassing species can lead to defects on directly metalized polymer surfaces. For example, microcracking of the metal coating on directly metalized thermoplastic bezels can sometimes occur on heating. Condensable outgassing species may migrate through these cracks onto the metalized surface, leading to cloudiness or loss of reflectance (“haze”) of the high gloss metalized surface.

WO 2004/106405 discloses a method for reducing condensable outgassing in polybutylene terephthalate (PBT) compositions comprising using PBT compositions having a “cyclic dimer” content of less than 0.3 wt %.

A need remains for polyester compositions or polymers having a polyester component with reduced levels of condensable outgassing and heat-age derived blooming, for use in thermoplastic molded parts having a metalized layer.

U.S. Pat. No. 6,441,129, Duh, et al, discloses a process for producing PTT at an increased solid state polymerization rate. The concentration of cyclic oligomer in the PTT provided by the process is not disclosed. Duh also discloses specific solid state polymerization processes in J. Appl. Polymer Sci., Vol 89, 3188-3200 (2003).

U.S. Pat. No. 7,332,561 discloses a PTT composition in the form of fine particles having a cyclic dimer content of 1.5% by weight or less, and a process fro making the composition.

### SUMMARY OF INVENTION

One aspect of the invention is a thermoplastic molded article comprising
a) poly(trimethylene terephthalate) molding resin comprising poly(trimethylene terephthalate) repeat units and end groups, said poly(trimethylene terephthalate) molding resin having a cyclic dimer content of less than or equal to 1.1 wt % as determined with nuclear magnetic resonance (NMR) analysis, based on the weight of said poly(trimethylene terephthalate) repeat units and said cyclic dimer; and an intrinsic viscosity in the range of 0.9 to 2.0 dL/g; and
b) at least one surface having a metal layer.

### BRIEF DESCRIPTION OF THE FIGURES

FIG. 1 shows the aromatic region of an NMR spectrum of a commercially available PTT resin having about 21 wt % cyclic dimer.

### DETAILED DESCRIPTION

The thermoplastic molded articles disclosed herein require a poly(trimethylene terephthalate) resin composition, referred to as the “PTT molding resin” having a cyclic dimer content of less than or equal to 1.1 wt %, and preferably about 0.65 to about 1.1 wt %, and about 0.7 to about 1.0 wt %, as determined with nuclear magnetic resonance analysis, based on the weight of said poly(trimethylene terephthalate repeat units and said cyclic dimer; and an intrinsic viscosity of about 0.9 to about 2.0 dL/g, preferably about 0.9 to about 1.30 dL/g, about 0.9 to about 1.20 dL/g; and about 1.0 to about 1.10 dL/g.

The PTT molding resin having the above defined properties can be made by a solid state polymerization of PTT particles as disclosed below. The PTT molding resins provided by the solid state polymerization process exhibit surprising and unexpected properties in terms of (1) rate of cyclic dimer formation upon melt testing; (2) blooming of cyclic dimer to the surface of molded parts; and (3) outgassing of cyclic dimer and other oligomers upon heat aging molded parts.

The solid state polymerization process is a process of making a high viscosity PTT molding resin having a low cyclic dimer content comprising (a) providing an initial poly(trimethylene terephthalate) resin composition comprising poly(trimethylene terephthalate) repeat units, in the form of a plurality of pellets having a pellet size of 3.0 to 4.0 g/100 pellets, said initial poly(trimethylene terephthalate) resin composition having an initial cyclic dimer content and one or more a condensation catalyst; said initial poly(trimethylene terephthalate) resin composition having an intrinsic viscosity of 0.50 to 0.89 dL/g; (b) heating and agitating the plurality of resin pellets to a condensation temperature for a condensation time to provide said high viscosity PTT molding resin having poly(trimethylene terephthalate) repeat units and having a low cyclic dimer content of less than or equal to 1.1 wt % as determined with nuclear magnetic resonance analysis and an intrinsic viscosity in the range of 0.9 to 2.0 dL/g; wherein the cyclic dimer content is based on the weight of said poly(trimethylene terephthalate) repeat units and said cyclic dimer.

The initial PTT resin composition useful in the solid state polymerization process comprises poly(trimethylene terephthalate) repeat units and end groups, and is in the form of a plurality of pellets having a pellet size of 3.0 to 4.0 g/100 pellets; and in one embodiment 3.0 to 3.4 g/100 pellets. The initial PTT resin composition has an initial cyclic dimer content, typically about 2.5%, but can range from about 1.5 to about 3.0 wt %. In various embodiments the initial cyclic dimer content is about 2.0 to 3.0 wt % and about 2.3 to about 2.8 wt %, based on the weight of said poly(trimethylene terephthalate) repeat units and said cyclic dimer. The initial PTT resin composition has an intrinsic viscosity of 0.50 to 0.89 dL/g, and in other embodiments, an intrinsic viscosity of 0.60 to 0.89 dL/g, 0.63 to 0.89 dL/g, and 0.63 to 0.80 dL/g.

PTT useful as the initial PTT resin composition is of the type made by polycondensation of terephthalic acid or acid equivalent and 1,3-propanediol; with the 1,3-propane diol preferably being of the type that is obtained biochemically from a renewable source, that is “biologically-derived” 1,3-propanediol.

As indicated above, the initial PTT resin composition comprises a predominant amount of a poly(trimethylene terephthalate).

Poly(trimethylene terephthalate) suitable for use in the invention are well known in the art, and conveniently prepared by polycondensation of 1,3-propane diol with terephthalic acid or terephthalic acid equivalent.

By “terephthalic acid equivalent” is meant compounds that perform substantially like terephthalic acids in reaction with polymeric glycols and diols, as would be generally recognized by a person of ordinary skill in the relevant art. Terephthalic acid equivalents include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of PTT are discussed, for example in U.S. Pat. No. 6,277,947 and commonly owned U.S. patent application Ser. No. 11/638919 (filed 14 Dec. 2006, entitled “Continuous Process for Producing Poly(trimethylene Terephthalate)”).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, hereby incorporated by reference. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The PTT based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and PTT based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol.1 of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. This latter half-life must not be taken literally; rather, one must use the detailed atmospheric nuclear input/decay function to trace the variation of atmospheric and biospheric ¹⁴C since the onset of the nuclear age. It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making PTT will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, hereby incorporated by reference.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

PTT useful in this invention can be PTT homopolymers (derived substantially from 1,3-propane diol and terephthalic acid and/or equivalent) and copolymers, by themselves or in blends. PTT used in the invention preferably contain about 70 mole % or more of repeat units derived from 1,3-propane diol and terephthalic acid (and/or an equivalent thereof, such as dimethyl terephthalate).

In one embodiment the initial poly(trimethylene terephthalate) resin useful in the solid state polymerization process and the PTT molding resin further comprises 0.1 to 30 mole % repeat units, other than poly(trimethylene terephthalate), made from monomers selected from the group consisiting of: terephthalic acid, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids; and diols ethylene glycol, 1,3-propane diol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol.

More preferably, the initial PTT resin and the PTT molding resin contains at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate)homopolymer (polymer of substantially only 1,3-propane diol and terephthalic acid or equivalent).

For PTT resin used herein, the cyclic dimer is of the following formula (I)

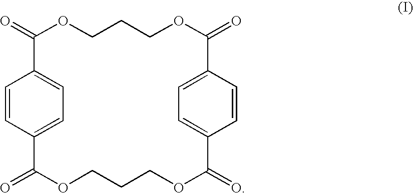

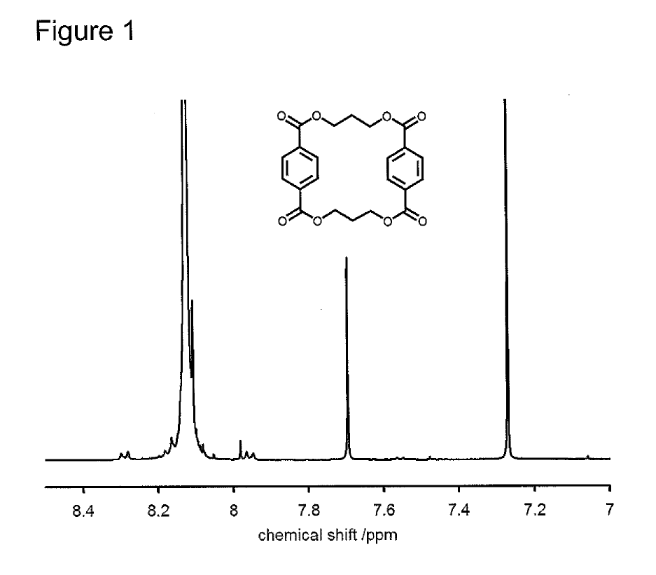

For determination of cyclic dimer content, many alternative methods are available including soxhlet extraction, high pressure liquid chromatography, and NMR analysis. For the purposes herein ¹H NMR analysis of the resin samples, in solution, has been chosen and is the basis for defining the bounds and limits of all claims herein. The analysis directly measures the content of all terephthalate groups in the polymer repeat units including the terepthalate present in any end groups, and in a separate and distinct region the terepthalate groups of the cyclic dimer. FIG. 1 shows the aromatic region of an NMR spectrum of a commercially available PTT, Sorona® Bright PTT resin, available from E. I. du Pont de Nemours & Co., Inc. Wilmington, Del., USA, having about 2.7 wt % cyclic dimer. The peak attributed to the cyclic dimer is at about 7.7 ppm, distinct from the PTT terephthalate repeat units at 8.1 ppm. The peak at about 7.27 ppm is deuterated chloroform.

The initial PTT resin and the PTT molding resin have one or more a condensation catalyst. In one embodiment the solid state polymerization is performed in the presence of one or more condensation catalyst at about 25 to about 200 ppm based on the weight of said initial poly(trimethylene terephthalate) resin composition. Preferred condensation catalysts are selected from the group consisting of titanium (IV) butoxide, titanium (IV) propoxide, antimony (III) oxide, dibutyltin oxide, germanium oxide, zirconium(IV) bis(diethyl citrato)dipropoxide, and combinations thereof

The heating and agitating the plurality of resin pellets to a condensation temperature can be done in any manner known to provide adequate and uniform heating and agitation sufficient to prevent the resin pellets sticking to one another. In various embodiments a rotary dryer, fluidized bed, and fluidized column reactor are used in the performing the solid state polymerization process.

Preferably the heating and agitating is performed in a rotary dryer and the condensation temperature is about 200 to about 210° C. Preferably the heating and agitating is performed under reduced pressure, that is, lower than atmospheric pressure. In various embodiments a reduced pressure of about 0.1 to about 10 mm Hg, 0.1 to 1 mm Hg, and 0.3 to 0.8 mm Hg is applied to the rotary dryer during heating and agitating.

The PTT molding resin may also include additives such as fillers lubricants, flow modifiers, heat stabilizers, antioxidants, dyes, pigments, UV stabilizer, and the like, provided that they don't negatively impact the physical properties or surface properties of the molded article.

Typically, the filler is any material commonly used in thermoplastic compositions, such as pigments, reinforcing agents, and other fillers. The filler may or may not have a coating on it, for example, a sizing and/or a coating to improve adhesion of the filler to the polymers of the composition. The filler may be organic or inorganic. Useful fillers are those selected from the group consisting of minerals such as clay, sepiolite, talc, wollastonite, mica, and calcium carbonate; glass in various forms such as fibers, milled glass, solid or hollow glass spheres; carbon as black or fiber; titanium dioxide; aramid in the form of short fibers, fibrils or fibrids; flame retardants such as antimony oxide, sodium antimonate, and a combination of two or more thereof. In various embodiments the resin composition further comprises one or more fillers at about 1 to 50 wt %, about 5 to about 45 wt %; and about 10 to 40 wt %, based on the total weight of the resin composition. In various embodiments fillers are wollastonite, mica, talc, glass especially glass fiber, titanium dioxide, and calcium carbonate.

Preferred lubricants or mold release agents for various embodiments are selected from the group consisting of pentaerythritol tetramontanate, butylene glycol dimontanate, calcium montanate, and mixtures thereof.

The PTT molding resin used in the present invention are in the form of a melt-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous. The sequence of mixing in the manufacture of the composition may be such that individual components may be melted in one shot, or the filler and/or other components may be fed from a side feeder, and the like, as will be understood by those skilled in the art.

The PTT molding resin may be formed into articles using methods known to those skilled in the art, such as, for example, injection molding. Such articles can include those for use in electrical and electronic applications, mechanical machine parts, and automotive applications.

The molded articles can be metalized to provide a metal layer on a portion of, or over the entire area of the molded articles, by any means known in the art. Preferably the metal layer is provided by vapor deposition or sputtering deposition on at least one surface of the molded article. Preferred metals for the metal layer are selected from the group consisting of aluminum, chrome, and stainless steel. Aluminum is a more preferred metal layer. Preferably the metal layer is a film of metal having a thickness of less than 1 micron and, preferably, about 500 Angstroms to about 1000 Angstroms, and more preferably about 600 to about 800 Angstroms.

Various embodiments of the invention are molded articles including metalized bezels for vehicles including those selected from the group consisting of tail light bezel, head light bezel, directional light bezel and interior light bezel.

### Methods

### Intrinsic Viscosity

The intrinsic viscosity (IV) was determined using viscosity measured with a Viscotek Forced Flow Viscometer Y900 (Viscotek Corporation, Houston, Tex.) for the polymers dissolved in 50/50 weight % trifluoroacetic acid/methylene chloride at a 0.4 grams/dL concentration at 19° C. following an automated method based on ASTM D 5225-92. The measured viscosity was then correlated with standard viscosities in 60/40 wt % phenol/1,1,2,2-tetrachloroethane as determined by ASTM D 4603-96 to arrive at the reported intrinsic values.

### Determination of Cyclic Dimer Content by NMR

4-6 pellets of PTT were melt pressed at 260° C. and melted for 5 minutes and subsequently pressed to 10,000 lbs of pressure to create a thin film (0.14 mm thick) to increase the surface area of the polymer for easy dissolution. The pressed film of polymer (15 mg) was added to CDCl₃/TFA-d (5:1, 1 mL) mixture and dissolved. The solution was transferred to a 5 mm NMR tube and analyzed within one hour of sample preparation. 64 scans were run at 30° C. with a 16 second delay time on a Varian INOVA 500 MHz NMR with a proton/fluorine/carbon probe. The obtained spectrum was integrated at the terephthalate region (8.1 ppm) and the cyclic dimer region (7.65 ppm). The weight percent of cyclic dimer is calculated by dividing the integration value of the cyclic dimer region by the sum of the integration values of the cyclic dimer region and the terephthalate region multiplied by 100.

### Melt Test of PTT Composition Particles at 260° C.

The melt test was the procedure as defined in U.S. Pat. No. 7,332,561, Column 15, method 8, with the exception that the cyclic dimer content was determined using the NMR method, as disclosed above. The test is a measure of the propensity for formation of cyclic dimer under melt conditions. The PTT pellet sample (1.0 g) was added to a glass ampule and sealed under vacuum. The ampule was heated at 260° C. for 30 minutes in a Bismuth/Tin alloy metal bath. After cooling to room temperature (RT), the ampule was broken and excess glass was removed from the polymer using liquid nitrogen.

### Light Bezel Fogging Test

The Fogging Test method was used to determine the tendency for molded parts to form sight reducing films of condensation on windows and automotive light bezel assemblies. A molded polymer disc was heated in a container at a programmed temperature and duration causing any volatile constituents to be condensed on a cooled glass disc. A fogging value was calculated as the quotient, in percent, of the reflectometer value of the glass disc with fogging condensates and the reflectometer value of the same glass disc without fogging condensates.

The test instrument consisted of a digital temperature controlled multi-position hot plate upon which were placed individual 83 mm×9.5 mm discs of aluminum into which was bored a hole to place a thermocouple for temperature control. A 63.5 mm diameter×50 mm tall vapor transmission cup containing a 50 mm×3.3 mm injection molded polymer test disc was placed onto each hotplate position. A 76.2 mm×3.175 mm clear silica glass disc was placed on each vapor cup, followed by a thin filter paper and then an aluminum condenser head, 90 mm×32 mm. The condenser head has a single center bore hole through which is piped a coolant solution at 80° C.

Measurements of the glass disc before and after the test were made using a glossmeter (Novo-Gloss) at a 60° measuring angle. Each disc was measured at four locations 90° rotation from each other, and the gloss value was recorded. The hot plates were programmed to a temperature of 160° C., and the test samples heated for 20 hours. The gloss value in the same locations as the clean measurements were measured and % fogging was calculated as F=(exposed disc gloss/clean disc gloss)*100 for each location and averaged for each sample. After heating, the test samples were visually inspected for the presence of white surface deposits referred to as “blooming”.

### Materials

Illustrated is the process for solid phase polymerization of poly(trimethylene terephthalate).

PTT-A. PTT resin (4682 Kg of pellets, E. I. du Pont de Nemours & Co., Inc. Wilmington, Del., USA) provided from continuous polymerization of 1,3-propanediol with dimethyl terephthalate in the presence of titanium (IV) n-butoxide (100 ppm) having 33±2 mg per pellet with dimensions 2.9±0.2×2.8±0.2×4.1±0.2 mm, with an inherent viscosity of 0.76 dL/g, and with a PTT cyclic dimer concentration of 2.5 weight %, was charged to a dual cone tumble drier (ABBE rotating dryer, model 24, Patterson, N.J., USA) The tumble drier was rotated at a rate of 4 revolutions per minute while heating at a rate of 10° C/h up to 207° C. The heating occurred under vacuum (0.41 mm Hg). The temperature of the drier was held at 209±2° C. for 30 hours. The dryer was cooled under vacuum until pellet temperature reached 60° C.; the vacuum was broken with nitrogen and the reactor was packed out under positive nitrogen pressure. The dryer was cooled at a rate of 21° C./h. The cyclic dimer concentration was measured after cool down. The cyclic dimer concentration was 0.77 weight %, as determined with NMR analysis disclosed in the Method Section, and the intrinsic viscosity (IV) was 1.25 dL/g as measured in the Method Section.

PTT-B. PTT resin (4682 Kg of pellets, E. I. du Pont de Nemours & Co., Inc. Wilmington, Del., USA) provided from continuous polymerization of 1,3-propanediol with dimethyl terephthalate in the presence of titanium (IV) n-butoxide (100 ppm) having 33±2 mg per pellet with dimensions 2.9±0.2×2.8±0.2×4.1±0.2 mm, with an inherent viscosity of 0.76 dL/g, and with a PTT cyclic dimer concentration of 2.5 weight %, was charged to a dual cone tumble drier (ABBE rotating dryer, model 24, Patterson, N.J., USA) The tumble drier was rotated at a rate of 4 revolutions per minute while heating at a rate of 10° C./h up to 205° C. under vacuum 0.52 mm Hg (69 Pa). The temperature of the drier was held at 205±24° C. for 11 hours. The dryer was cooled under vacuum until pellet temperature reached 60° C.; the vacuum was broken with nitrogen and the reactor was packed out under positive nitrogen pressure. The dryer was cooled at a rate of 25° C./h to provide the solid phase polymerization pellets having a cyclic dimer concentration of 0.82 weight % as determined with NMR and the intrinsic viscosity (IV) of 1.14 dL/g.

PTT-C is Sorona® Bright PTT resin, available from E. I. du Pont de Nemours & Co., Inc. Wilmington, Del., USA, having an IV of 1.02 dL/g and 2.7 wt % cyclic dimer.

CaCO₃ is Albagloss® calcium carbonate available from Pfizer Inc., Minerals Pigments and Metals Division, Easton, Pa.

C-Black is a carbon black color concentrate consisting of a 50:50 wt blend of carbon black and PBT available from Clariant Corp. (Charlotte, N.C. 28205, USA).

Licomont ET141 is a pentaerythritol tetramontanate mold release lubricant available from Clariant Corp. (Charlotte, N.C. 28205, USA).

TSP is trisodium phosphate, anhydrous.

TiO₂ is Millenium RCL4® titanium dioxide available from Ticona.

BaSO₄ was provided by Sacht-Leben, Germany

### Examples 1-6

Using the PTT-A, having cyclic dimer concentration of 0.77 weight % and the intrinsic viscosity (IV) was 1.25 dL/g, the resin compositions listed in Table 1 were prepared using a twin screw extruder (W&P 28/30 extruder) at a rate of 40-50 pounds per hour at a screw speed of 300 rpm, barrel temperature of 270° C. and a melt temperature of 306 to 314° C. to provide compounded pellets.

The compounded PTT-A pellets were molded into 50 mm×3.3 mm test discs using a single screw injection molding machine (6 oz variable tonnage, HPM, Mount Gillian, Ohio, USA. The molding equipment was run at 150 tons. The melt temperature was 270° C. The mold temperature and cycle time of the plaques were 90° C. and 30 seconds respectfully.

The test discs were subjected to the Light Bezel Fogging Test at as disclosed above. The condensibles %-gloss retention; and appearance of residue on test piece after the test were recorded.

The compounded PTT-A pellets were injection molded to provide articles in the form of 3 in×6 in×0.12 in plaques. The plaques were metalized in a evaporative vacuum system with no pretreatment. The aluminum was applied to approximately 800 Angstrom film thickness followed by a topcoating with hexamethyldisiloxane at about 450 Angstrom. Table 1 list comments with regard to the visual appearance of the metalized layer.

### Comparative Example C-1

Components listed in Table 1, including a PTT resin not having undergone the solid state processing as disclosed herein, and having an IV of 1.02 dL/g and 2.7 wt % cyclic dimer, were compounded in a similar manner to Examples 1-6 with 260° C. barrel settings at 50 pounds per hour, 300 rpm and melt temperature of 294° C.

TABLE 1

| | Example | | | | | | |
|---|---|---|---|---|---|---|---|
| | 1 | 2 | 3 | 4 | 5 | 6 | C-1 |
| PTT-A | 98.30 | 98.70 | 68.40 | 69.40 | 68.70 | 69.70 | |
| PTT-C | | | | | | | 69.70 |
| Hytrel 4556 | | | 9.00 | 9.00 | 9.00 | 9.00 | 9.00 |
| CaCO₃ | | | | | | | 20.0 |
| TiO₂ | | | 20.00 | | 20.00 | | |
| BaSO₄ | | | | 20.00 | | 20.00 | |
| TSP | 0.40 | | 0.30 | 0.30 | | | |
| ET141 | 0.30 | 0.30 | 0.30 | 0.30 | 0.30 | 0.30 | |
| OP Wax | | | | | | | 0.20 |
| Irganox 1010 | | | | | | | 0.10 |
| C-Black | 1.00 | 1.00 | 2.00 | 1.00 | 2.00 | 1.00 | 1.00 |
| Total | 100.00 | 100.00 | 100.00 | 100.00 | 100.00 | 100.00 | 100.0 |
| Testing | | | | | | | |
| Melt Viscosity | 260 | 219 | 252 | 260 | 259 | 253 | 228 |
| 250° C., Pa · sec | | | | | | | |
| Condensibles | 85.48 | 76.43 | 75.98 | 88.13 | 65.65 | 35.35 | 82.5 |
| %-gloss | | | | | | | |
| retention | | | | | | | |
| Residue on test | no | no | No | no | no | no | Surface |
| piece | | | | | | | deposit |
| Metal layer | speckled | High | Speckled | speckled | Slightly | hazy | NA |
| Visual | | gloss | | | hazy | | |
| appearance | | | | | | | |

The results listed in Table 1 indicate that the articles of the invention having a cyclic dimer content of less than or equal to 1.1 wt %, and an intrinsic viscosity of about 0.9 to about 2.0 dL/g provides molded parts that do not exhibit surface deposits, or blooming upon heat treatment; and upon metalization without pre-treatment of surface, show desirable visual appearance.

### Example 7

A mixture of the PTT-B resin (98.7 parts), having a cyclic dimer concentration of 0.82 weight % as determined with NMR and the intrinsic viscosity (IV) of 1.14 dL/g, ET141 lubricant (0.3 parts) and C-black (1.0 part) was compounded using a twin screw extruder (Coperion ZSK-26, Ramsey, N.J., USA) at a rate of 100 lbs/h at a screw speed of 450 rpm and barrel temperature of 271° C. and melt temperature of 305° C. to provide compounded pellets.

The compounded PTT-B pellets were molded into 3 in×6 in×0.12 in plaques using a single screw injection molding machine The molding machine was a 123 ton Nissei, with a 36 mm diameter screw and a 5 ounce shot size capacity. The plaque mold was a single cavity design. The PTT-B resin melt temperature was 260-265° C. and the mold steel temperature was 80° C. The overall cycle time was approximately 40 seconds.

The plaques were metalized in a evaporative vacuum system with no pretreatment. The aluminum was applied to approximately 800 Angstrom film thickness followed by a topcoating with hexamethyldisiloxane at about 450 Angstrom.

### Comparative Example C-2

A comparison sample was made using a commercially available grade of poly(butylene terephthalate) (PBT) that is used in many headlamp bezel applications in North America. Plaques were molded using Crastin® CE 2055 BKB580 PBT, available from E. I. du Pont de Nemours & Co., Inc. Wilmington, Del., USA, in the same equipment as listed in Example 7. The resin melt temperature was 250-255° C., the mold temperature was 50° C., and the cycle time was 40 seconds.

The Plaques were metalized in the same manner as Example 7.

Samples of both Example 7 and Comparative Example C2 metalized plaques were heated in an oven at 150° C., 165° C., and 173° C., respectively, for 90 minutes in an air atmosphere. This test demonstrated the upper limits for metalized plaque stability. Failure mode was typically hazing, fogging or an iridescence from cracking of the aluminum layer. The results of the heat treatment are listed in Table 2.

TABLE 2

| Example | 7 | C-2 |
|---|---|---|
| Control, No heat | 1 | 1 |
| 150° C., 90 min | 1 | 4 - H, I |
| 165° C., 90 min | 2 - H, S | 5 - H, I |
| 173° C., 90 min | 2 - H, S | 5 - H, I |

1 = No Change
2 = Very slight blemish
3 = Slight blemish
4 = Noticeable blemish
5 = Significant blemish
I = iridescence,
H = haze,
S = scratches and/or lines

The results indicated that metalized plaques prepared in Example 7 from PTT-B pellets having an intrinsic viscosity (IV) of 1.14 dL/g; and a cyclic dimer content of 0.82 wt. %; exhibited surprising and unexpected improved thermal stability over conventional PBT resins used in preparation of metalized Bezels.

The PTT-B pellets having an intrinsic viscosity (IV) of 1.14 dL/g; and a cyclic dimer content of 0.82 wt. % exhibited a slightly better surface appearance as molded and as metalized as compared to the Comparative Example C-2 using Crastin Ce 2055 BKB580. Thus, Example 7 using the PTT-B pellets having an intrinsic viscosity (IV) of 1.14 dL/g; and a cyclic dimer content of 0.82 wt. % demonstrates unexpectedly improve performance in use in metalized headlight bezel as well as other lighting applications where good surface appearance, low outgassing, and high temperature metalized performance is required.

What is claimed is:

1. A thermoplastic molded article comprising
a) poly(trimethylene terephthalate) molding resin comprising poly(trimethylene terephthalate) repeat units and end groups, said poly(trimethylene terephthalate) molding resin having a cyclic dimer content of less than or equal to 1.1 wt %, as determined with nuclear magnetic resonance analysis, based on the weight of said poly(trimethylene terephthalate) repeat units and said cyclic dimer; and an intrinsic viscosity of 0.9 to about 2.0 dL/g; and
b) at least one surface having a metal layer.

2. The thermoplastic molded article of claim 1 wherein the metal layer is provided by vapor deposition or sputtering deposition.

3. The thermoplastic molded article of claim 1 wherein the metal layer is selected from the group consisting of aluminum, chrome, and stainless steel.

4. The thermoplastic molded article of claim 1 wherein the metal layer is aluminum.

5. The thermoplastic molded article of claim 1 further comprising a lubricant selected from the group consisting of pentaerythritol tetramontanate, butylene glycol dimontanate, calcium montanate, and mixtures thereof.

6. The thermoplastic molded article of claim 1 wherein the poly(trimethylene terephthalate) molding resin has an intrinsic viscosity of about 0.9 to about 1.30 dL/g.

7. The thermoplastic molded article of any claims 1-6 that is a vehicle light bezel.

8. The light bezel of claim 7 that is selected from the group consisting of tail light bezel, head light bezel, interior light automotive light bezel.
